(19) United States
(12) Patent Application Publication
(10) Pub. No.: US 2025/0274187 A1
(43) Pub. Date: Aug. 28, 2025

(54) TRANSMISSION CONFIGURATION INDICATION STATE APPLICATION TIMING AFTER LOWER-LAYER TRIGGERED MOBILITY CELL SWITCH

(71) Applicant: QUALCOMM Incorporated, San Diego, CA (US)

(72) Inventors: Doohyun SUNG, Basking Ridge, NJ (US); Wooseok NAM, San Diego, CA (US); Changhwan PARK, San Diego, CA (US); Yan ZHOU, San Diego, CA (US); Jelena DAMNJANOVIC, Del Mar, CA (US)

(21) Appl. No.: 18/894,983

(22) Filed: Sep. 24, 2024

Related U.S. Application Data
(60) Provisional application No. 63/558,445, filed on Feb. 27, 2024.

(51) Int. Cl. H04B 7/06; H04W 36/08; H04W 36/32; H04W 74/0833

(52) U.S. Cl. CPC H04B 7/06952; H04W 36/085; H04W 74/0833; H04W 36/32

(57) ABSTRACT

Various aspects of the present disclosure generally relate to wireless communication. In some aspects, a user equipment (UE) may receive a lower-layer triggered mobility (LTM) cell switch command that indicates a transmission configuration indication (TCI) state and a first synchronization signal block (SSB) index, wherein the TCI state indicated in the LTM cell switch command is associated with a second SSB index that differs from the first SSB index. The UE may communicate using a beam associated with the first SSB index until a first time, wherein the first time is related to a random access channel (RACH) procedure triggered by the LTM cell switch command. The UE may communicate using the TCI state associated with the second SSB index starting at a second time, wherein the second time is related to the first time. Numerous other aspects are described.

### CROSS-REFERENCE TO RELATED APPLICATION

This patent application claims priority to U.S. Provisional Patent Application No. 63/558,445, filed on Feb. 27, 2024, entitled “TRANSMISSION CONFIGURATION INDICATION STATE APPLICATION TIMING AFTER LOWER-LAYER TRIGGERED MOBILITY CELL SWITCH,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with transmission configuration indication (TCI) state application timing after a lower-layer triggered mobility (LTM) cell switch.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to receive a lower-layer triggered mobility (LTM) cell switch command that indicates a transmission configuration indication (TCI) state and a first synchronization signal block (SSB) index, wherein the TCI state indicated in the LTM cell switch command is associated with a second SSB index that differs from the first SSB index. The one or more processors may be configured to communicate using a beam associated with the first SSB index until a first time, wherein the first time is related to a random access channel (RACH) procedure triggered by the LTM cell switch command. The one or more processors may be configured to communicate using the TCI state associated with the second SSB index starting at a second time, wherein the second time is related to the first time.

Some aspects described herein relate to a method of wireless communication performed by a UE. The method may include receiving an LTM cell switch command that indicates a TCI state and a first SSB index, wherein the TCI state indicated in the LTM cell switch command is associated with a second SSB index that differs from the first SSB index. The method may include communicating using a beam associated with the first SSB index until a first time, wherein the first time is related to a RACH procedure triggered by the LTM cell switch command. The method may include communicating using the TCI state associated with the second SSB index starting at a second time, wherein the second time is related to the first time.

Some aspects described herein relate to an apparatus for wireless communication. The apparatus may include means for receiving an LTM cell switch command that indicates a TCI state and a first SSB index, wherein the TCI state indicated in the LTM cell switch command is associated with a second SSB index that differs from the first SSB index. The apparatus may include means for communicating using a beam associated with the first SSB index until a first time, wherein the first time is related to a RACH procedure triggered by the LTM cell switch command. The apparatus may include means for communicating using the TCI state associated with the second SSB index starting at a second time, wherein the second time is related to the first time.

Some aspects described herein relate to a non-transitory computer-readable medium that stores a set of instructions for wireless communication by a UE. The set of instructions, when executed by one or more processors of the UE, may cause the UE to receive an LTM cell switch command that indicates a TCI state and a first SSB index, wherein the TCI state indicated in the LTM cell switch command is associated with a second SSB index that differs from the first SSB index. The set of instructions, when executed by one or more processors of the UE, may cause the UE to communicate using a beam associated with the first SSB index until a first time, wherein the first time is related to a RACH procedure triggered by the LTM cell switch command. The set of instructions, when executed by one or more processors of the UE, may cause the UE to communicate using the TCI state associated with the second SSB index starting at a second time, wherein the second time is related to the first time.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a synchronization signal hierarchy, in accordance with the present disclosure.

FIG. 5 is a diagram illustrating an example of a four-step random access channel procedure, in accordance with the present disclosure.

FIGS. 6-7 are diagrams illustrating examples of lower-layer triggered mobility (LTM), in accordance with the present disclosure.

FIG. 8 is a diagram illustrating an example of an LTM procedure, in accordance with the present disclosure.

FIG. 9 is a diagram illustrating an example associated with associated with transmission configuration indication (TCI) state application timing after an LTM cell switch, in accordance with the present disclosure.

FIG. 10 is a flowchart illustrating an example process performed, for example, by a UE, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

To enhance multi-beam operation at higher carrier frequencies, a wireless network may support efficient (e.g., low latency and/or low overhead) downlink and/or uplink beam management operations to support Layer 1 and/or Layer 2 (L1/L2)-centric inter-cell mobility. For example, L1/L2 signaling may be referred to as “lower-layer” signaling and may be used to activate and/or deactivate candidate cells in a set of cells configured for lower-layer triggered mobility (LTM), also known as L1/L2 triggered mobility, and/or to provide reference signals for measurement by the UE 120 (e.g., such that the UE 120 may select a candidate beam as a target beam for a lower-layer handover operation). Accordingly, one goal for L1/L2-centric inter-cell mobility is to enable a UE to perform a cell switch via dynamic control signaling at lower layers (for example, DCI for L1 signaling or a medium access control (MAC) control element (MAC-CE) for L2 signaling), rather than semi-static Layer 3 (L3) RRC signaling, in order to reduce latency, reduce overhead, and/or otherwise increase efficiency of the cell switch.

For example, a UE may receive a MAC-CE that carries an LTM cell switch command, which may allow the UE to switch to a configured LTM target cell without having to perform a random access channel (RACH) procedure in the LTM target cell in cases where the LTM cell switch command includes a valid timing advance command, or a measured timing advance associated with the LTM target cell is available. Otherwise, the UE may perform a contention-free RACH procedure in the LTM target cell, which may start with a physical RACH (PRACH) preamble transmission in a RACH occasion that is selected according to a synchronization signal block (SSB) index indicated in the LTM cell switch command. Furthermore, the UE may communicate with the LTM target cell using a transmission configuration indication (TCI) state indicated in the LTM cell switch command. However, in some cases, the TCI state indicated in the LTM cell switch command may be associated with an SSB index that differs from the SSB index used to select the RACH occasion for the contention-free RACH procedure in the LTM target cell. In such cases, the UE may need to use the SSB index indicated in the LTM cell switch command to start the contention-free RACH procedure, and may switch from the SSB index indicated in the LTM cell switch command to the SSB index associated with the indicated TCI state.

Various aspects relate generally to techniques to define UE behavior and a corresponding TCI state switching delay when an LTM cell switch command indicates a first SSB index for selecting a RACH occasion in an LTM target cell and indicates a TCI state associated with a second SSB index that differs from the first SSB index. For example, as described herein, the UE may generally communicate using a beam associated with the first SSB index until a first time that is related to a RACH procedure performed in the LTM target cell, and may start to communicate using the TCI state indicated in the LTM cell switch command at a second time that relates to the first time.

Particular aspects of the subject matter described in this disclosure can be implemented to realize one or more of the following potential advantages. In some examples, by defining UE behavior and a corresponding TCI state switching delay when an LTM cell switch command indicates a first SSB index for selecting a RACH occasion in an LTM target cell and indicates a TCI state associated with a second SSB index that differs from the first SSB index, the described techniques can be used to enable flexibility in indicating an SSB index that the UE is to use to perform a contention-free RACH procedure in an LTM target cell and an SSB index that the UE is to use for downlink and/or uplink communication in the LTM target cell.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

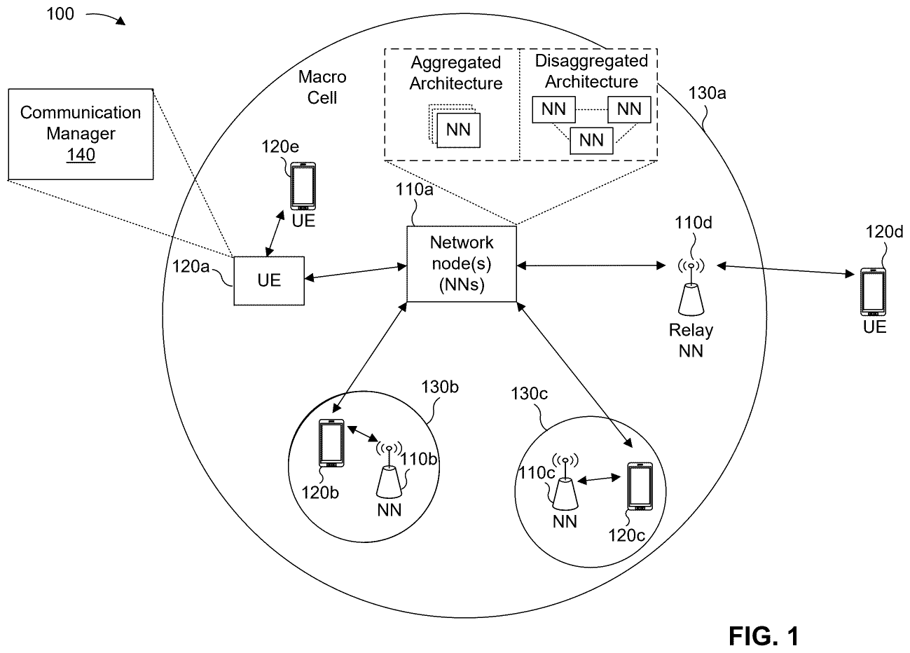

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FRI is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

The network node 110 may provide the UE 120 with a configuration of TCI states that indicate or correspond to beams that may be used by the UE 120, such as for receiving one or more communications via a physical channel. For example, the network node 110 may indicate (for example, using DCI) an activated TCI state to the UE 120, which the UE 120 may use to generate a beam for receiving one or more communications via the physical channel. A beam indication may be, or may include, a TCI state information element, a beam identifier (ID), spatial relation information, a TCI state ID, a closed loop index, a panel ID, a TRP ID, and/or a sounding reference signal (SRS) set ID, among other examples. A TCI state information element (sometimes referred to as a TCI state herein) may indicate particular information associated with a beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, or a qcl-TypeD, among other examples), a cell identification (for example, a ServCellIndex), a bandwidth part identification (bwp-Id), or a reference signal identification, such as a CSI-RS identification (for example, an NZP-CSI-RS-Resourceld or an SSB-Index, among other examples). Spatial relation information may similarly indicate information associated with an uplink beam. The beam indication may include a joint DL/UL beam indication or separate DL/UL beam indications in a unified TCI framework. In a unified TCI framework, a network node 110 may support common TCI state ID update and activation, which may provide commons QCL and/or common UL transmission spatial filters across a set of configured component carriers. This type of beam indication may apply to intra-band carrier aggregation, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured component carriers.

In some aspects, the UE 120 may include a communication manager 140. As described in more detail elsewhere herein, the communication manager 140 may receive an LTM cell switch command that indicates a TCI state and a first SSB index, wherein the TCI state indicated in the LTM cell switch command is associated with a second SSB index that differs from the first SSB index; communicate using a beam associated with the first SSB index until a first time, wherein the first time is related to a RACH procedure triggered by the LTM cell switch command; and communicate using the TCI state associated with the second SSB index starting at a second time, wherein the second time is related to the first time. Additionally, or alternatively, the communication manager 140 may perform one or more other operations described herein.

As indicated above, FIG. 1 is provided as an example. Other examples may differ from what is described with regard to FIG. 1.

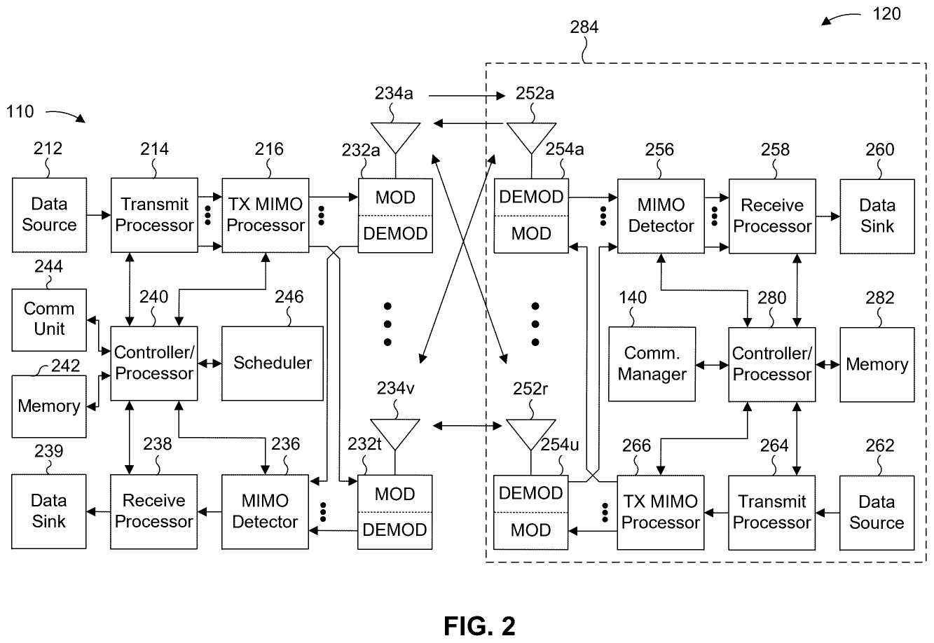

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

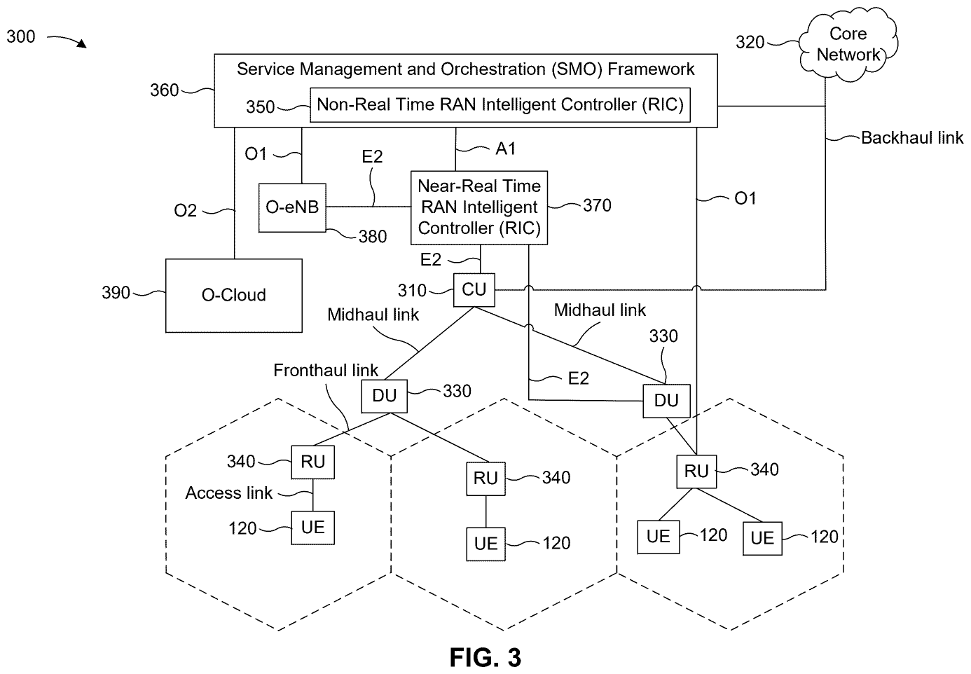

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

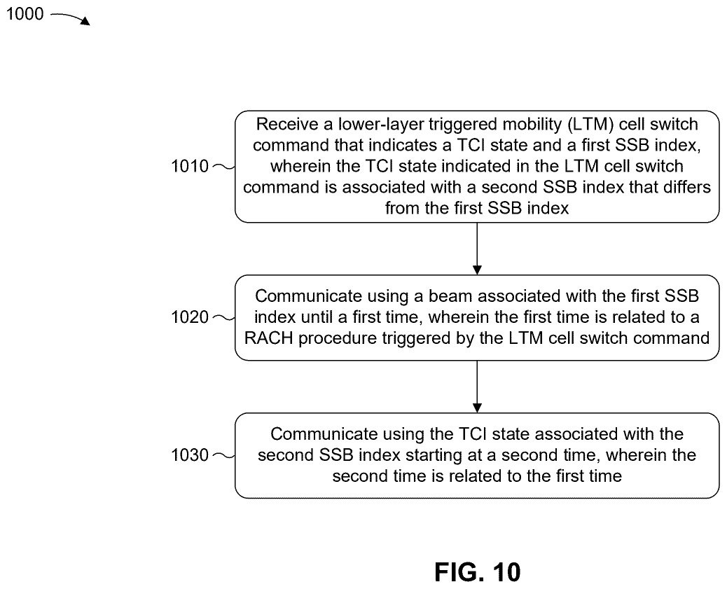

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with TCI state application timing after an LTM cell switch command, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10 or other processes as described herein. In some examples, executing instructions may include running the instructions, converting the instructions, compiling the instructions, and/or interpreting the instructions, among other examples.

In some aspects, the UE 120 includes means for receiving an LTM cell switch command that indicates a TCI state and a first SSB index, wherein the TCI state indicated in the LTM cell switch command is associated with a second SSB index that differs from the first SSB index; means for communicating using a beam associated with the first SSB index until a first time, wherein the first time is related to a RACH procedure triggered by the LTM cell switch command; and/or means for communicating using the TCI state associated with the second SSB index starting at a second time, wherein the second time is related to the first time. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

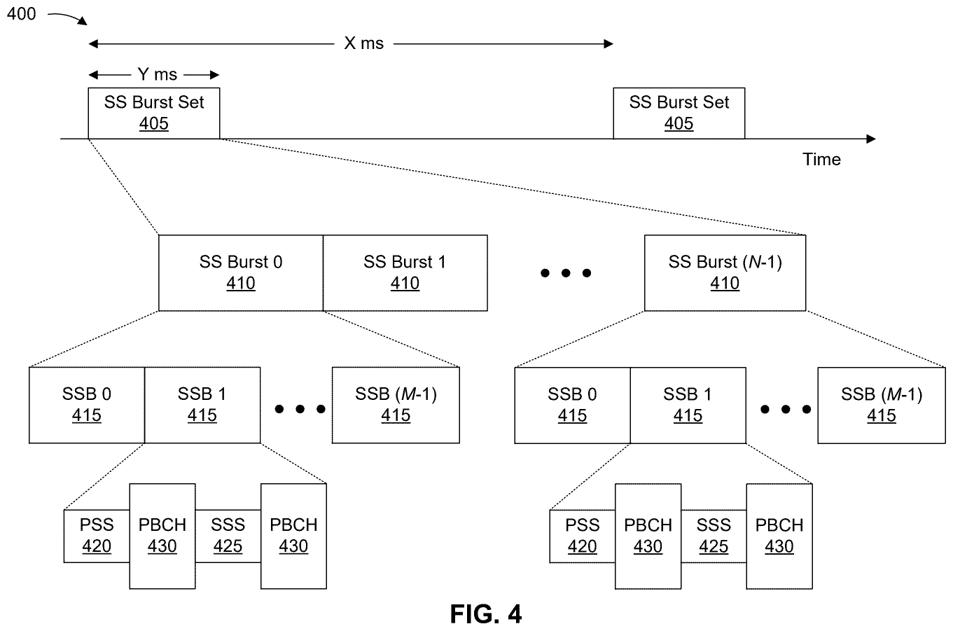

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SSBs 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., a highest RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a RACH procedure). Additionally, or alternatively, the UE 120 may use the SSB 415 and/or the SSB index to determine a cell timing for a cell via which the SSB 415 is received (e.g., a serving cell).

As indicated above, FIG. 4 is provided as an example. Other examples may differ from what is described with regard to FIG. 4.

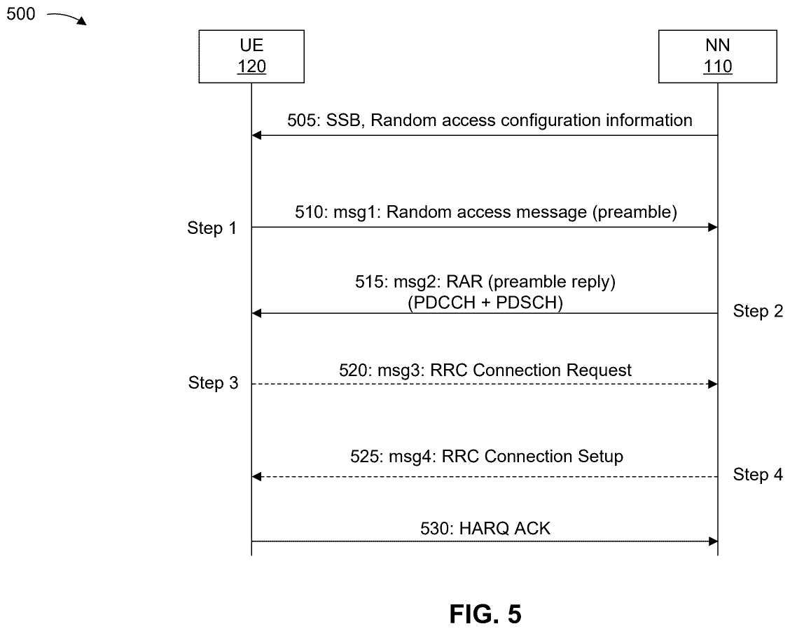

FIG. 5 is a diagram illustrating an example 500 of a four-step RACH procedure, in accordance with the present disclosure. As shown in FIG. 5, a network node 110 and a UE 120 may communicate with one another to perform the four-step RACH procedure.

As shown by reference number 505, the network node 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message (RAM) and/or one or more parameters for receiving a RAR message.

As shown by reference number 510, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step RACH procedure. The RAM may include a random access preamble identifier.

As shown by reference number 515, the network node 110 may transmit a RAR message as a reply to the preamble. The message that includes the RAR message may be referred to as message 2, msg2, MSG2, or a second message in a four-step RACH procedure. In some aspects, the RAR message may indicate the detected random access preamble identifier (e.g., received from the UE 120 in msg1). Additionally, or alternatively, the RAR message may indicate a resource allocation to be used by the UE 120 to transmit message 3 (msg3).

In some aspects, as part of the second step of the four-step RACH procedure, the network node 110 may transmit a PDCCH communication for the RAR message. The PDCCH communication may schedule a PDSCH communication that includes the RAR message. For example, the PDCCH communication may indicate a resource allocation for the PDSCH communication. Also as part of the second step of the four-step RACH procedure, the network node 110 may transmit the PDSCH communication for the RAR message, as scheduled by the PDCCH communication. The RAR message may be included in a MAC protocol data unit (PDU) of the PDSCH communication.

As shown by reference number 520, the UE 120 may transmit an RRC connection request message. The RRC connection request message may be referred to as message 3, msg3, MSG3, or a third message of a four-step RACH procedure. In some aspects, the RRC connection request may include a UE identifier, UCI, and/or a PUSCH communication (e.g., an RRC connection request).

As shown by reference number 525, the network node 110 may transmit an RRC connection setup message. The RRC connection setup message may be referred to as message 4, msg4, MSG4, or a fourth message of a four-step RACH procedure. In some aspects, the RRC connection setup message may include the detected UE identifier, a timing advance value, and/or contention resolution information. As shown by reference number 530, if the UE 120 successfully receives the RRC connection setup message, the UE 120 may transmit a HARQ ACK.

As indicated above, FIG. 5 is provided as an example. Other examples may differ from what is described with regard to FIG. 5.

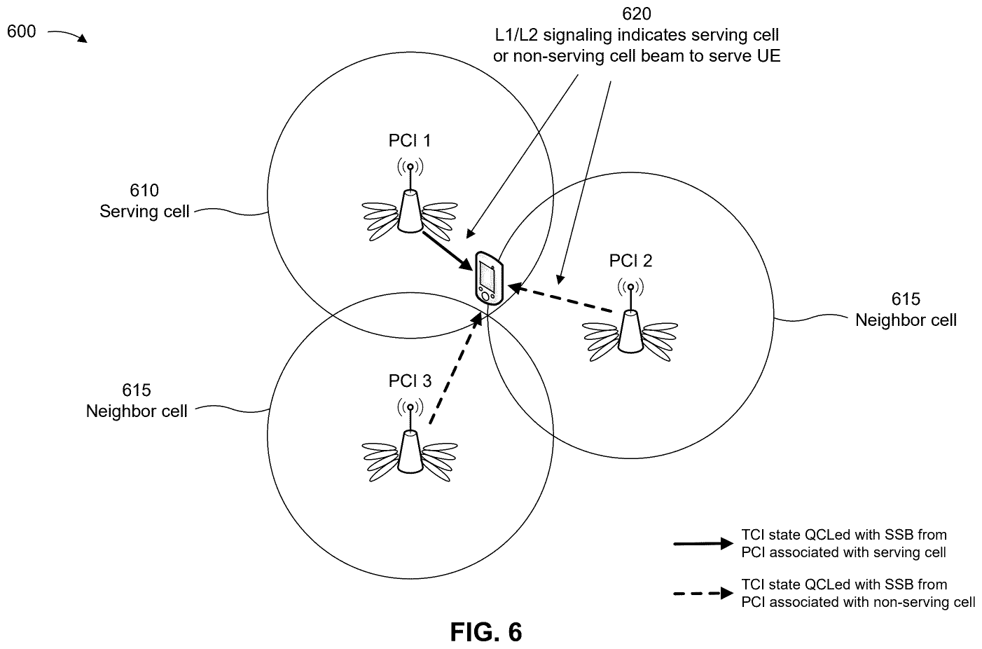

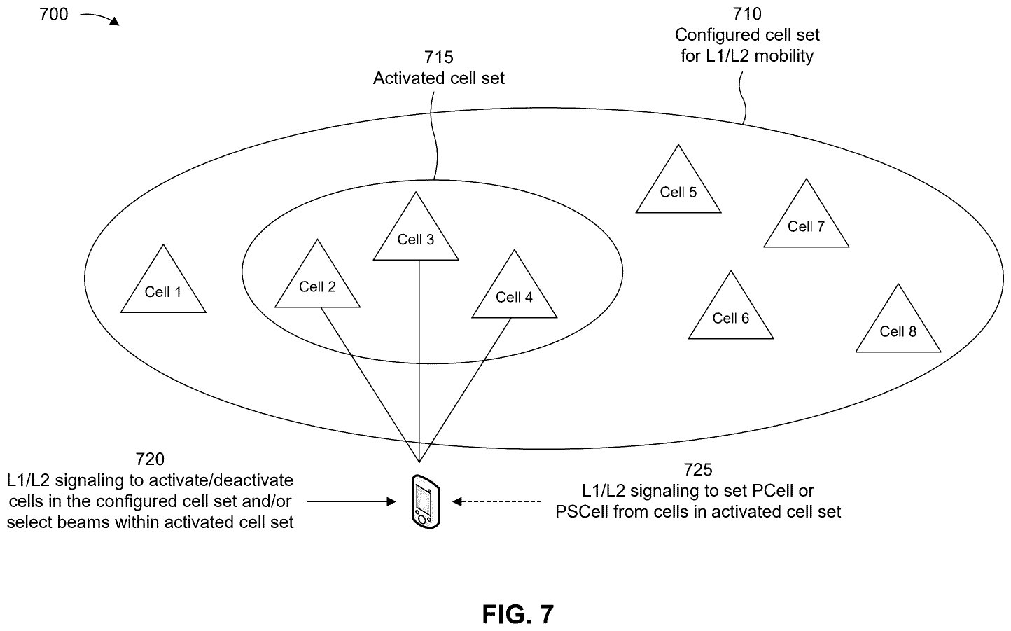

FIG. 6 and FIG. 7 are diagrams illustrating examples 600 and 700 of LTM, in accordance with the present disclosure.

In a wireless network, a UE and a network node may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation at higher carrier frequencies is facilitation of efficient (e.g., low latency and low overhead) downlink and/or uplink beam management to support L1/L2-centric inter-cell mobility, also known as L1/L2-triggered mobility or lower-layer triggered mobility (LTM). Accordingly, one goal for LTM is to enable a UE to perform a cell switch via dynamic control signaling at lower layers (e.g., DCI for L1 signaling or a MAC-CE for L2 signaling) rather than semi-static Layer 3 (L3) RRC signaling to reduce latency, reduce overhead, and/or otherwise increase efficiency of the cell switch.

For example, FIG. 6 illustrates an example 600 of a first LTM technique, which may be referred to as beam-based inter-cell mobility, dynamic point selection based inter-cell mobility, and/or non-serving cell-based inter-cell mobility, among other examples. As described in further detail herein, the first LTM technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where LTM is not supported (e.g., cell switches are triggered only by an L3 handover), beam selection for control information and for data is typically limited to beams within a physical cell identity (PCI) associated with a serving cell. In contrast, in a wireless network that supports the first LTM technique (e.g., as shown in FIG. 6), beam selection for control and data may be expanded to include any beams within a serving cell 610 or one or more non-serving neighbor cells 615 configured for LTM (e.g., LTM candidate cells).

For example, in the first LTM technique shown in FIG. 6, a UE may be configured with a single serving cell 610, and may be further configured with a neighbor cell set that includes one or more non-serving cells 615 configured for LTM. In general, the serving cell 610 and the non-serving cell(s) 615 configured for LTM may be associated with a common CU and a common DU, or the serving cell 610 and the non-serving cell(s) 615 configured for LTM may be associated with a common CU and different DUs. In some aspects, as shown by reference number 620, a network node may trigger an LTM handover for a UE using L1/L2 signaling (e.g., DCI or a MAC-CE) that indicates a selected TCI state quasi co-located (QCL'ed) with a reference signal (e.g., an SSB) associated with a PCI. For example, in FIG. 6, the UE may be communicating with the serving cell 610 using a TCI state that is QCL′ed with an SSB from a PCI associated with the serving cell 610 (e.g., shown as PCI 1 in FIG. 6), and L1/L2 signaling may trigger inter-cell mobility by indicating that the UE is to switch to communicating using a TCI state that is QCL'ed with an SSB from a PCI associated with a non-serving neighbor cell 615 (e.g., shown as PCI 2 in FIG. 6). Accordingly, in the first LTM technique, the network node (e.g., the common CU controlling the serving cell 610 and the non-serving neighbor cell(s) 615) may use L1/L2 signaling to select a beam from either the serving cell 610 or a non-serving neighbor cell 615 to serve the UE.

In this way, relative to restricting L1/L2 beam selection to beams within the serving cell 610, the first L1/L2 inter-cell mobility technique may be more robust against blocking and may provide more opportunities for higher rank spatial division multiplexing across different cells. However, the first LTM technique does not enable support for changing a special cell (SpCell) for a UE, where an SpCell may be a primary cell (PCell) or a primary secondary cell (PSCell). Rather, in the first LTM technique, triggering an SpCell change is performed via a legacy L3 handover using RRC signaling. In this respect, the first LTM technique is associated with a limitation in that L1/L2 signaling can only be used to indicate a beam from the serving cell 610 or a configured neighbor cell 615 while the UE is in the coverage area of the serving cell 610 (e.g., because L1/L2 signaling cannot be used to change the PCell or PSCell). Accordingly, FIG. 7 illustrates an example 700 of a second LTM technique, which May be referred to as serving cell-based inter-cell mobility, among other examples. As described in further detail herein, the second LTM technique may enable a network node to use L1/L2 signaling (e.g., DCI or a MAC-CE) to indicate control information associated with an activated cell set and/or a deactivated cell set and/or to indicate a change to an SpCell within the activated cell set.

For example, as shown in FIG. 7, the second LTM technique may use mechanisms that are generally similar to carrier aggregation to enable LTM, except that different cells configured for LTM may be on the same carrier frequency. As shown in FIG. 7, a network node may configure a cell set 710 for LTM (e.g., using RRC signaling). As further shown, an activated cell set 715 may include one or more cells in the configured cell set 710 that are activated and ready to use for data and/or control transfer. Accordingly, in the second LTM technique, a deactivated cell set may include one or more cells that are included in the cell set 710 configured for LTM but are not included in the activated cell set 715. However, the cells that are included in the deactivated cell set can be readily activated, and thereby added to the activated cell set 715, using L1/L2 signaling. Accordingly, as shown by reference number 720, L1/L2 signaling can be used for mobility management of the activated cell set 715. For example, in some aspects, L1/L2 signaling can be used to activate cells within the configured cell set 710 (e.g., to add cells to the activated cell set 715), to deactivate cells in the activated cell set 715, and/or to select beams within the cells included in the activated cell set 715. In this way, the second LTM technique may enable seamless mobility among the cells included in the activated cell set 715 using L1/L2 signaling (e.g., using beam management techniques).

Furthermore, as shown by reference number 725, the second LTM technique enables L1/L2 signaling to be used to set or change an SpCell (e.g., a PCell or PSCell) from the cells included in the activated cell set 715. Additionally, or alternatively, when the cell to become the new SpCell is in the deactivated cell set (e.g., is included in the cell set 710 configured for LTM but not the activated cell set 715), L1/L2 signaling can be used to move the cell from the deactivated cell set to the activated cell set 715 before further L1/L2 signaling is used to set the cell as the new SpCell. However, in the second LTM technique, an L3 handover (e.g., using RRC signaling) is used to change the SpCell when the new SpCell is not included in the cell set 710 configured for LTM. In such cases, RRC signaling associated with the L3 handover may be used to update the cells included in the cell set 710 configured for LTM. Accordingly, LTM techniques can provide more efficient cell switching to support multi-beam operation, enabling lower latency and reduced overhead by using L1 signaling (e.g., DCI) and/or L2 signaling (e.g., a MAC-CE) rather than L3 signaling (e.g., RRC) to change the beam(s) that a UE uses to communicate over an access link.

As indicated above, FIG. 6 and FIG. 7 are provided as examples. Other examples may differ from what is described with regard to FIG. 6 and FIG. 7.

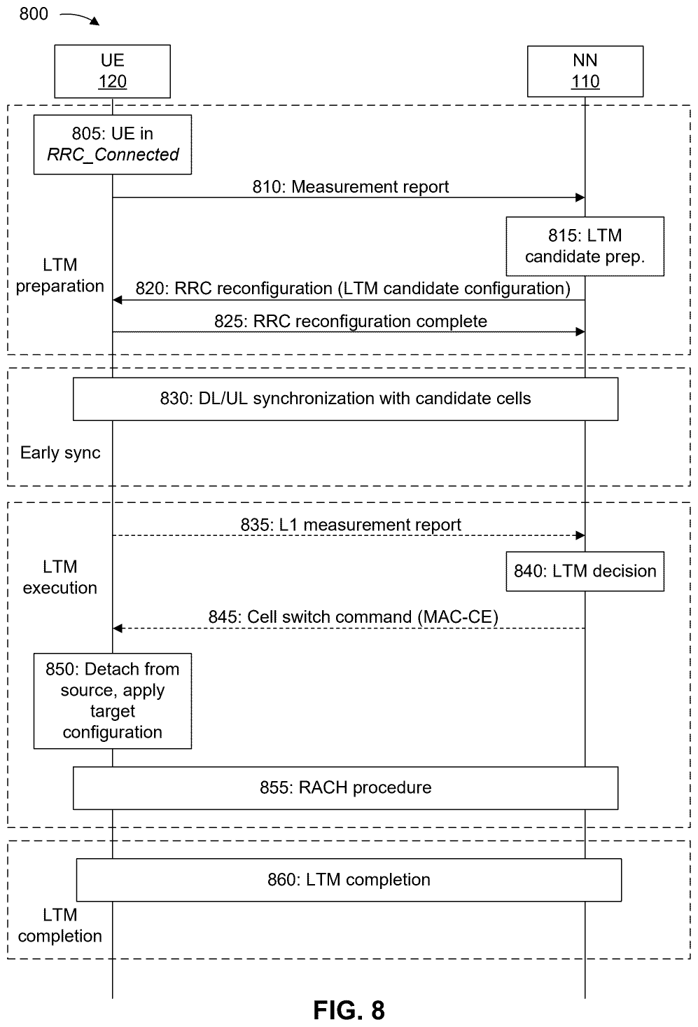

FIG. 8 is a diagram illustrating an example 800 of an LTM procedure, in accordance with the present disclosure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the example 800 LTM procedure shown in FIG. 8. As shown in FIG. 8, the LTM procedure may include an LTM preparation phase, an early synchronization phase (shown as “early sync” in FIG. 8), an LTM execution phase, and/or an LTM completion phase.

During the LTM preparation phase, and as shown by reference number 805, the UE 120 may be in an RRC connected state (sometimes referred to as RRC_Connected) with a source cell. As shown by reference number 810, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some examples, based at least in part on the measurement report or other information, the network node 110 may decide to use LTM, and thus, as shown by reference number 815, the network node 110 may initiate LTM candidate preparation.

As shown by reference number 820, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate cells, which may be candidate cells to become a serving cell of the UE and/or cells for which the UE 120 may later be triggered to perform an LTM procedure. As shown by reference number 825, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 830, the UE 120 may optionally perform downlink and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 855.

During the LTM execution phase, and as shown by reference number 835, the UE 120 may perform L1 measurements on the configured LTM candidate cells, and thus may transmit, to the network node 110, lower-layer (e.g., L1) measurement reports. As shown by reference number 840, based at least in part on the lower-layer measurement reports, the network node 110 may decide to execute an LTM cell switch to an LTM target cell. Accordingly, as shown by reference number 845, the network node 110 may transmit, and the UE 120 may receive, a MAC-CE or similar message triggering an LTM cell switch (the MAC-CE or similar message is sometimes referred to herein as a cell switch command, an LTM cell switch command MAC-CE, a MAC-CE carrying a cell switch command, or the like). The cell switch command may include an indication of a candidate configuration index associated with the LTM target cell. As shown by reference number 850, based at least in part on receiving the cell switch command, the UE 120 may switch to the configuration of the LTM target cell (e.g., the UE 120 may detach from the source cell and apply the configuration of the LTM target cell). Moreover, as shown by reference number 855, the UE 120 may perform a RACH procedure towards the LTM target cell, such as when a timing advance associated with the target cell is not available (e.g., in examples in which the UE 120 did not perform the early synchronization as described above in connection with reference number 830 and/or the LTM cell switch command does not indicate a valid timing advance for the LTM target cell).

During the LTM completion phase, and as shown by reference number 860, the UE 120 may indicate successful completion of the LTM cell switch towards the LTM target cell. In this way, a cell switch or handover to a target cell may be performed using less overhead than an L3 handover procedure and/or a reduced latency relative to an L3 handover procedure.

As indicated above, FIG. 8 is provided as an example. Other examples may differ from what is described with respect to FIG. 8.

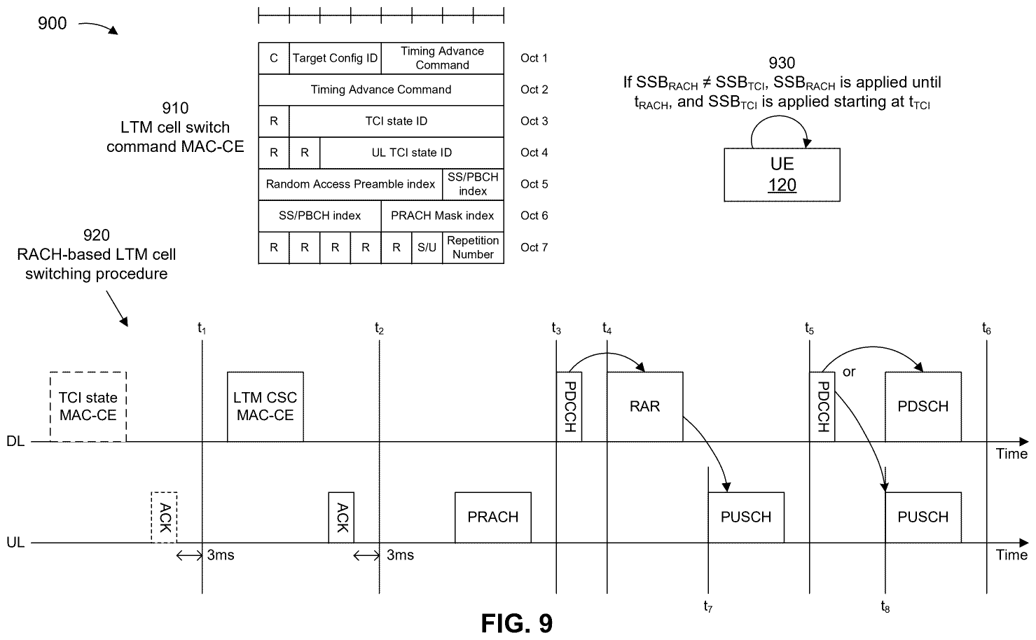

FIG. 9 is a diagram illustrating an example 900 associated with associated with TCI state application timing after an LTM cell switch, in accordance with the present disclosure. More particularly, as described herein, a wireless network may support one or more LTM techniques to trigger a handover using L1/L2 signaling to significantly reduce a handover latency, relative to a legacy L3 handover, which is typically triggered by an RRC message (e.g., an RRC reconfiguration message).

For example, as shown by reference number 910 in FIG. 9, an LTM handover from a source cell to an LTM target cell may be triggered using an LTM cell switch command MAC-CE. As shown in FIG. 9, the LTM cell switch command MAC-CE includes various fields, including a target configuration ID field (e.g., identifying a configuration associated with the LTM target cell), a timing advance command field, one or more TCI state ID fields (e.g., indicating a joint downlink and uplink TCI state, or separate downlink and/or uplink TCI states), a random access preamble index field, an SS/PBCH (or SSB) index field, a PRACH mask index field, an uplink carrier field (shown as “S/U”) indicating whether a supplemental uplink (SUL) carrier or a normal uplink (NUL) carrier is used to transmit a PRACH using contention-free random access resources, a repetition number field that may indicate a PRACH (or msg1) repetition number (e.g., 2, 4, or 8) to be applied for contention-free random access or indicate that the PRACH repetition number does not apply, and/or a field (shown as “C”) that indicates whether contention-free random access resource fields (e.g., the random access preamble index field, the S/U field, the SS/PBCH field, and/or the PRACH mask index field) are present or absent. As described herein, the LTM cell switch command MAC-CE shown in FIG. 9 is an example only, and may include one or more additional fields and/or omit one or more fields relative to the LTM cell switch command MAC-CE shown in FIG. 9. For example, one or more of the reserved (R) fields in the LTM cell switch command MAC-CE may be used for other indicators.

In some aspects, in cases where the LTM cell switch command MAC-CE includes a valid timing advance command for the LTM target cell, or a measured timing advance is otherwise available to the UE, the UE may perform the LTM handover without having to perform a RACH procedure toward the LTM target cell. For example, when a valid timing advance is available for the LTM target cell, the timing advance command in the LTM cell switch command MAC-CE may indicate an index value TA to control a timing adjustment applied by the UE and that the UE can skip a RACH procedure for the LTM target cell. Otherwise, the timing advance command in the LTM cell switch command MAC-CE may be set to a given value (e.g., FFF) when a valid timing advance or timing adjustment is unavailable for the LTM target cell, in which case the UE may perform a contention-free RACH procedure to connect to the LTM target cell. For example, in some aspects, the UE may select a RACH occasion in which to transmit a PRACH preamble according to the SSB index indicated in the SS/PBCH index field of the LTM cell switch command MAC-CE.

For example, reference number 920 corresponds to an example of a RACH-based LTM cell switching procedure that a UE may perform when an LTM cell switch command MAC-CE does not include a valid timing advance command for an LTM target cell and a measured timing advance associated with the LTM target cell is not available to the UE. As shown by reference number 920, prior to receiving the LTM cell switch command MAC-CE (shown as LTM CSC MAC-CE), a network node may optionally transmit, and a UE may receive, a candidate cell TCI state activation and/or deactivation MAC-CE (shown as TCI state MAC-CE). For example, in some aspects, the candidate cell TCI state activation and/or deactivation MAC-CE may activate or deactivate one or more TCI states (e.g., joint downlink and uplink TCI states, downlink-only TCI states, and/or uplink-only TCI states) for one or more LTM candidate cells, such that the network node can subsequently trigger an LTM handover to an LTM candidate cell associated with an activated TCI state with a reduced interruption time. As further shown in FIG. 9, the UE may then transmit an acknowledgement (ACK) in response to the candidate cell TCI state activation and/or deactivation MAC-CE, and may be ready to receive an LTM cell switch command MAC-CE that indicates a TCI state activated by the candidate cell TCI state activation and/or deactivation MAC-CE three milliseconds (ms) after transmitting the ACK.

As further shown in FIG. 9, the network node may transmit, and the UE may receive, an LTM cell switch command MAC-CE that triggers an LTM handover to an LTM target cell. The UE may then transmit an ACK in response to the LTM cell switch command MAC-CE, and may be expected to perform the cell switch 3 ms after transmitting the ACK. In particular, as described herein, the UE may perform the cell switch without performing a RACH procedure in the LTM target cell if the LTM cell switch command MAC-CE indicates a valid timing advance command, or if a measured timing advance for the LTM target cell is available to the UE. Otherwise, the UE may perform a RACH procedure in the LTM target cell if the LTM cell switch command MAC-CE does not indicate a valid timing advance command and a measured timing advance for the LTM target cell is unavailable to the UE. For example, as shown, the UE may transmit a PRACH (e.g., a msg1 communication) to the LTM target cell in a RACH occasion that is selected in accordance with the SSB index indicated in the LTM cell switch command MAC-CE. As shown in FIG. 9, the RACH procedure may include various additional steps, including a first PDCCH transmission that schedules an RAR message (e.g., a msg2 communication), a PUSCH transmission (e.g., a msg3 communication) scheduled by an uplink grant carried in the RAR message, and a second PDCCH communication (e.g., a msg4 communication) that schedules a PDSCH transmission to the UE and/or a PUSCH transmission by the UE.

Accordingly, in cases where the UE performs a contention-free or contention-based RACH procedure in the LTM target cell (e.g., because the LTM cell switch command MAC-CE does not indicate a valid timing advance command and the UE has not already performed downlink/uplink synchronization to obtain a measured timing advance for the LTM target cell), the UE may use the SSB index indicated in the SS/PBCH index field of the LTM cell switch command MAC-CE, SSB_{RACH}, to select the RACH occasion in which to transmit the PRACH preamble. However, the LTM cell switch command MAC-CE also includes one or more TCI state identifiers (e.g., the “TCI state ID” field may indicate a joint downlink and uplink TCI state, or the “TCI state ID” field may indicate a downlink TCI state and the “UL TCI state ID” field may indicate a separate uplink TCI state). The LTM target cell associated with the TCI state(s) indicated in the LTM cell switch command may be associated with an SSB index, SSB_{TCI}, to be used for downlink and/or uplink communication with the LTM target cell. For example, as described herein, the TCI state ID field may indicate a joint downlink and uplink TCI state or a separate downlink TCI state associated with an SSB index, SSB_{TCI-DL}. Furthermore, when separate downlink and uplink TCI states are indicated, the TCI state ID field may indicate a separate uplink TCI state associated with an SSB index, SSB_{TCI-UL}. In cases where the SSB index used to select the RACH occasion is the same as the SSB index associated with the indicated TCI state(s) (e.g., SSB_{RACH}=SSB_{TCI}), the UE may generally apply the TCI state(s) indicated in the LTM cell switch command MAC-CE from the first downlink and/or uplink transmission in the LTM target cell. However, in some cases, the LTM cell switch command MAC-CE may indicate an SSB_{RACH} index that differs from the SSB_{TCI} index.

In some aspects, when the LTM cell switch command MAC-CE indicates an SSB_{RACH} index that differs from the SSB_{TCI} index associated with the indicated TCI state (e.g., SSB_{RACH}≠SSB_{TCI}), the LTM cell switch command may be considered invalid, in cases where an LTM configuration does not allow the LTM cell switch command MAC-CE to indicate an SSB_{RACH} index that differs from the SSB_{TCI} index associated with the indicated TCI state. Alternatively, an LTM configuration may allow the LTM cell switch command MAC-CE to indicate an SSB_{RACH} index that differs from the SSB_{TCI} index associated with the indicated TCI state. In such cases, the UE may need to determine appropriate timing for when to use the SSB_{RACH} index to select a beam for the RACH procedure, and when to apply the TCI state associated with the SSB_{TCI} index for downlink and/or uplink communication in the LTM target cell. In addition, the timing for when to use the SSB_{RACH} index and when to apply the TCI state associated with the SSB_{TCI} index may define a switching delay or switching latency, including an interruption time (e.g., for switching from SSB_{RACH} to SSB_{TCI}).

For example, as shown by reference number 930, the UE may generally use the SSB_{RACH} index for configuring a downlink QCL and an uplink spatial filter until a first time, t_{RACH}. In some aspects, the UE may generally use the SSB_{RACH} index to configure a beam (e.g., a downlink QCL and/or an uplink spatial filter) until completion of one or more messages and/or steps associated with the RACH performed in the LTM target cell. For example, in some aspects, the UE may use the SSB_{RACH} index to configure a downlink and/or uplink beam until completion of the PRACH transmission (e.g., t_{RACH}=t₃), until completion of the PDCCH that schedules reception of the RAR message (e.g., t_{RACH}=t₄), until completion of reception of the PDSCH corresponding to the RAR message (e.g., t_{RACH}=t₅), until completion of a PUSCH transmission scheduled by a grant carried in the RAR message (e.g., t_{RACH}=t₆), or until the RACH procedure is declared successful by the UE (e.g., until successful decoding of the RAR message for contention-free random access, until successful contention resolution via msg4 for contention-based random access, and/or until another condition is satisfied, such as a successful RACH condition defined in 3GPP Technical Specification 38.321). In some aspects, in cases where the LTM cell switch command MAC-CE indicates a PRACH repetition number (e.g., the repetition number field is set to a value other than 0), the UE may perform multiple repetitions of the PRACH transmission, which may shift the time at which the PRACH transmission is complete (e.g., t₃), the time at which the PDCCH that schedules reception of the RAR message is complete (e.g., t₄), the time at which reception of the PDSCH corresponding to the RAR message is complete (e.g., t₅), the time at which a PUSCH transmission scheduled by a grant carried in the RAR message is complete (e.g., t₆), and/or the time at which the RACH procedure is declared successful by the UE later in time, depending on the number of PRACH repetitions.

As further shown by reference number 930, the UE may start to apply the TCI state indicated in the LTM cell switch command starting at a second time, t_{TCI}, which may be related to the first time, t_{RACH}, and/or related to whether the TCI state indicated in the LTM cell switch command is a known or unknown TCI state. For example, a joint downlink and uplink TCI state, or separate downlink and uplink TCI states indicated in the LTM cell switch command MAC-CE, may be known if various conditions are satisfied during a period from a last transmission of a reference signal resource used for L1-RSRP measurement reporting for the target downlink and/or uplink TCI state to the completion of the LTM cell switch (where the reference signal resource for L1-RSRP measurement is a reference signal in the target downlink and/or uplink TCI state or QCLed with the target downlink and/or uplink TCI state). For example, the joint downlink and uplink TCI state or separate downlink and uplink TCI states indicated in the LTM cell switch command MAC-CE may be known if the LTM cell switch command is received within 1280 ms upon (e.g., after) the last transmission of the reference signal resource for beam reporting or measurement, the UE has sent at least one L1-RSRP report for the target downlink and/or uplink TCI state before the LTM cell switch command, the target downlink and/or uplink TCI state remains detectable during the LTM cell switching period, the SSB associated with the target downlink and/or uplink TCI state (SSB_{TCI}) remains detectable during the cell switching period, and a signal-to-noise ratio of the TCI state satisfies (e.g., equals or exceeds) a threshold, such as −3 dB. Otherwise, if the above conditions are not satisfied, the TCI state indicated in the LTM cell switch command is considered unknown.

Accordingly, in some aspects, the UE may start to use the SSB_{TCI} index to communicate with the LTM target cell immediately after using the SSB_{RACH} index (e.g., t_{TCI}=t_{RACH}). Alternatively, in some aspects, the UE may start to use the SSB_{TCI} index (e.g., may apply the indicated TCI state) at least a minimum time gap after t_{RACH}. For example, in cases where the SSB_{TCI} index is associated with a known TCI state that was activated by the candidate cell TCI state activation and/or deactivation MAC-CE, the UE may start to apply the TCI state indicated in the LTM cell switch command at least a minimum time gap after t₁, which is 3 ms after the UE transmits the ACK in response to the optional candidate cell TCI state activation and/or deactivation MAC-CE (e.g., t_{TCI}=max (t_{RACH}, t₁+t_{gap1}), or t_{TCI}−t₁≥t_{gap1}, where t_{gap1} may be a time until an earliest SSB_{TCI} measurement occasion after t₁, plus an SSB processing time, such as 2 ms).

Alternatively, in cases where the SSB_{TCI} index is associated with a known TCI state that is inactive (e.g., the network node did not transmit the candidate cell TCI state activation and/or deactivation MAC-CE, or the candidate cell TCI state activation and/or deactivation MAC-CE did not activate the TCI state indicated in the LTM cell switch command MAC-CE), the UE may start to apply the TCI state indicated in the LTM cell switch command at least a minimum time gap after t₂, which is 3 ms after the UE transmits the ACK in response to the LTM cell switch command MAC-CE (e.g., t_{TCI}=max (t_{RACH}, t₂+t_{gap2}), or t_{TCI}−t₂≥t_{gap2}, where t_{gap2} may be a time until an earliest SSB_{TCI} measurement occasion after t₂, plus an SSB processing time, such as 2 ms).

Alternatively, in cases where the SSB_{TCI} index is associated with an unknown TCI state, the UE may start to apply the TCI state indicated in the LTM cell switch command at least a minimum time gap after t₂, which is 3 ms after the UE transmits the ACK in response to the LTM cell switch command MAC-CE, except that the minimum time gap may have a different value than the case where the SSB_{TCI} index is associated with a known TCI state that is inactive. For example, in cases where the SSB_{TCI} index is associated with an unknown TCI state, the UE may start to apply the indicated TCI state at t_{TCI}=max (t_{RACH}, t₂+t_{gap3}, or t_{TCI}−t₂≥t_{gap3}), where t_{gap3} may be a time until an Mth SSB_{TCI} measurement occasion after t₂, plus an SSB processing time, such as 2 ms. In such cases, M may be an integer having a value greater than two (e.g., M=8 or another suitable value), to allow the UE to perform multiple measurements of the SSB associated with the SSB_{TCI} index. In some aspects, the value of M may be dependent on an implementation and/or capability of the UE (e.g., based on a number of SSB measurements that are needed to obtain downlink and/or uplink synchronization).

In some aspects, in cases where t_{RACH} is earlier than t_{TCI} (e.g., t_{RACH}<t_{TCI}), a time duration between t_{RACH} and t_{TCI} may define an interruption time associated with switching from the SSB_{RACH} index to the SSB_{TCI} index. For example, the interruption time may generally correspond to a time period when the UE cannot perform downlink and/or uplink communication, because the UE is switching SSBs (e.g., switching beams and/or communication configurations). Accordingly, during a time period between t_{RACH} and t_{TCI} (for a joint downlink/uplink TCI state) and/or a time period between t_{RACH} and t_{TCI-DL} (for a downlink-only TCI state), the UE may refrain from monitoring a PDCCH and a PDSCH. Furthermore, during a time period between t_{RACH} and t_{TCI} (for a joint downlink/uplink TCI state) and/or a time period between t_{RACH} and t_{TCI-UL} (for a separate uplink TCI state), the UE may not transmit a PUCCH and a PUSCH.

In some aspects, in cases where the LTM cell switch command MAC-CE indicates a downlink TCI state and a separate uplink TCI state, a common application time may be used for both the downlink TCI state and the uplink TCI state (e.g., t_{TCI-DL}=t_{TCI-UL}). For example, in such cases, a later time between a first application time associated with the downlink TCI state, t_{TCL_DL}, and a second application time associated with the uplink TCI state, t_{TCL_UL}, may be used as the common application time (e.g., t_{TCI}=max (t_{TCI-DL}, t_{TCI-UL})). Alternatively, in some aspects, the downlink TCI state and the uplink TCI state may be associated with separate application times. For example, the UE may apply the downlink TCI state starting at the first application time, t_{TCI-DL}, and may apply the uplink TCI state starting at the second application time, t_{TCL-UL}.

Accordingly, in some aspects, the UE may use the techniques described herein to determine how long to apply the SSB_{RACH} index indicated in the LTM cell switch command MAC-CE (e.g., until t_{RACH}) and when to start applying the TCI state indicated in the LTM cell switch command when the SSB_{TCI} index is different from the SSB_{RACH} index (e.g., starting at t_{TCI}). Furthermore, in such cases, the LTM cell switch may be considered successful based on the UE successfully performing the RACH procedure in the LTM target cell, or based on the UE successfully receiving at least one downlink transmission or successfully performing at least one uplink transmission using the indicated TCI state associated with the SSB_{TCI} index.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with TCI state application timing after an LTM cell switch.

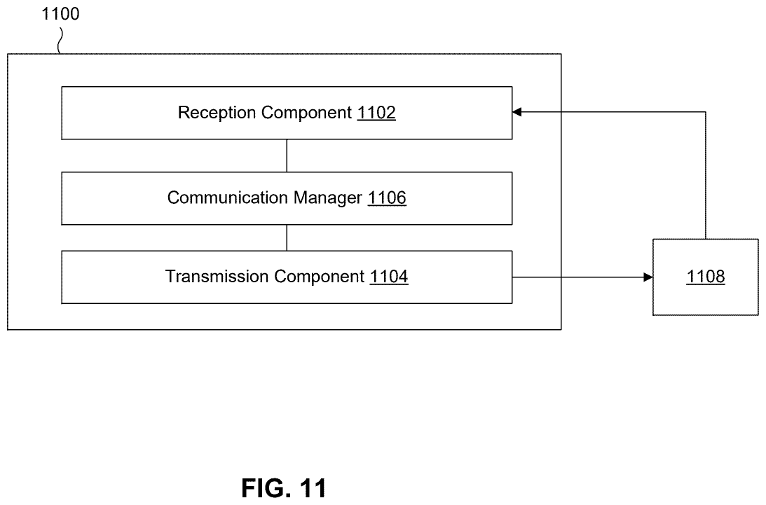

As shown in FIG. 10, in some aspects, process 1000 may include receiving an LTM cell switch command that indicates a TCI state and a first SSB index, wherein the TCI state indicated in the LTM cell switch command is associated with a second SSB index that differs from the first SSB index (block 1010). For example, the UE (e.g., using reception component 1102 and/or communication manager 1106, depicted in FIG. 11) may receive an LTM cell switch command that indicates a TCI state and a first SSB index, wherein the TCI state indicated in the LTM cell switch command is associated with a second SSB index that differs from the first SSB index, as described above.

As further shown in FIG. 10, in some aspects, process 1000 may include communicating using a beam associated with the first SSB index until a first time, wherein the first time is related to a RACH procedure triggered by the LTM cell switch command (block 1020). For example, the UE (e.g., using reception component 1102, transmission component 1104, and/or communication manager 1106, depicted in FIG. 11) may communicate using a beam associated with the first SSB index until a first time, wherein the first time is related to a RACH procedure triggered by the LTM cell switch command, as described above.

As further shown in FIG. 10, in some aspects, process 1000 may include communicating using the TCI state associated with the second SSB index starting at a second time, wherein the second time is related to the first time (block 1030). For example, the UE (e.g., using reception component 1102, transmission component 1104, and/or communication manager 1106, depicted in FIG. 11) may communicate using the TCI state associated with the second SSB index starting at a second time, wherein the second time is related to the first time, as described above.

Process 1000 may include additional aspects, such as any single aspect or any combination of aspects described below and/or in connection with one or more other processes described elsewhere herein.

In a first aspect, the first time is related to transmission of a PRACH associated with the RACH procedure.

In a second aspect, alone or in combination with the first aspect, the first time is related to reception of a PDCCH scheduling a RAR message associated with the RACH procedure.

In a third aspect, alone or in combination with one or more of the first and second aspects, the first time is related to reception of a RAR message associated with the RACH procedure.

In a fourth aspect, alone or in combination with one or more of the first through third aspects, the first time is related to transmission of a PUSCH scheduled by a RAR message associated with the RACH procedure.

In a fifth aspect, alone or in combination with one or more of the first through fourth aspects, the first time is related to successful completion of the RACH procedure.

In a sixth aspect, alone or in combination with one or more of the first through fifth aspects, the second time corresponds to the first time.

In a seventh aspect, alone or in combination with one or more of the first through sixth aspects, the second time is at least a minimum time gap after a time that is related to reception of a MAC-CE activating the TCI state indicated in the LTM cell switch command.

In an eighth aspect, alone or in combination with one or more of the first through seventh aspects, the minimum time gap is a time until an earliest measurement occasion associated with the second SSB index after the time that is related to reception of the MAC-CE activating the TCI state, plus an SSB processing time.

In a ninth aspect, alone or in combination with one or more of the first through eighth aspects, the second time is at least a minimum time gap after a time that is related to reception of a MAC-CE carrying the LTM cell switch command.

In a tenth aspect, alone or in combination with one or more of the first through ninth aspects, the minimum time gap is a time until an earliest measurement occasion associated with the second SSB index after the time that is related to reception of the MAC-CE carrying the LTM cell switch command, plus an SSB processing time.

In an eleventh aspect, alone or in combination with one or more of the first through tenth aspects, the minimum time gap is a time until an Mth measurement occasion associated with the second SSB index after the time that is related to reception of the MAC-CE carrying the LTM cell switch command, plus an SSB processing time, where M is an integer having a value greater than or equal to two.

In a twelfth aspect, alone or in combination with one or more of the first through eleventh aspects, an interruption time associated with switching from the beam associated with the first SSB index to the TCI state associated with the second SSB index is related to a duration between the first time and the second time.

In a thirteenth aspect, alone or in combination with one or more of the first through twelfth aspects, a PDCCH and a PDSCH are not monitored during the interruption time.

In a fourteenth aspect, alone or in combination with one or more of the first through thirteenth aspects, a PUCCH and a PUSCH are not transmitted during the interruption time.

In a fifteenth aspect, alone or in combination with one or more of the first through fourteenth aspects, the TCI state indicated in the LTM cell switch command includes a downlink TCI state and an uplink TCI state, and the second time is a common application time applied to both the downlink TCI state and the uplink TCI state.

In a sixteenth aspect, alone or in combination with one or more of the first through fifteenth aspects, the common application time is a later of a first application time associated with the downlink TCI state or a second application time associated with the uplink TCI state.

In a seventeenth aspect, alone or in combination with one or more of the first through sixteenth aspects, the TCI state indicated in the LTM cell switch command includes a downlink TCI state and an uplink TCI state, and the second time is separately applied to the downlink TCI state and the uplink TCI state.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 9. Additionally, or alternatively, the apparatus 1100 may be configured to perform one or more processes described herein, such as process 1000 of FIG. 10. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an LTM cell switch command that indicates a TCI state and a first SSB index, wherein the TCI state indicated in the LTM cell switch command is associated with a second SSB index that differs from the first SSB index. The reception component 1102 and/or the transmission component 1104 may communicate using a beam associated with the first SSB index until a first time, wherein the first time is related to a RACH procedure triggered by the LTM cell switch command. The reception component 1102 and/or the transmission component 1104 may communicate using the TCI state associated with the second SSB index starting at a second time, wherein the second time is related to the first time.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving an LTM cell switch command that indicates a TCI state and a first SSB index, wherein the TCI state indicated in the LTM cell switch command is associated with a second SSB index that differs from the first SSB index; communicating using a beam associated with the first SSB index until a first time, wherein the first time is related to a RACH procedure triggered by the LTM cell switch command; and communicating using the TCI state associated with the second SSB index starting at a second time, wherein the second time is related to the first time.

Aspect 2: The method of Aspect 1, wherein the first time is related to transmission of a PRACH associated with the RACH procedure.

Aspect 3: The method of any of Aspects 1-2, wherein the first time is related to reception of a PDCCH scheduling a RAR message associated with the RACH procedure.

Aspect 4: The method of any of Aspects 1-3, wherein the first time is related to reception of a RAR message associated with the RACH procedure.

Aspect 5: The method of any of Aspects 1-4, wherein the first time is related to transmission of a PUSCH scheduled by a RAR message associated with the RACH procedure.

Aspect 6: The method of any of Aspects 1-5, wherein the first time is related to successful completion of the RACH procedure.

Aspect 7: The method of any of Aspects 1-6, wherein the second time corresponds to the first time.

Aspect 8: The method of any of Aspects 1-7, wherein the second time is at least a minimum time gap after a time that is related to reception of a MAC-CE activating the TCI state indicated in the LTM cell switch command.

Aspect 9: The method of Aspect 8, wherein the minimum time gap is a time until an earliest measurement occasion associated with the second SSB index after the time that is related to reception of the MAC-CE activating the TCI state, plus an SSB processing time.

Aspect 10: The method of any of Aspects 1-9, wherein the second time is at least a minimum time gap after a time that is related to reception of a MAC-CE carrying the LTM cell switch command.

Aspect 11: The method of Aspect 10, wherein the minimum time gap is a time until an earliest measurement occasion associated with the second SSB index after the time that is related to reception of the MAC-CE carrying the LTM cell switch command, plus an SSB processing time.

Aspect 12: The method of Aspect 10, wherein the minimum time gap is a time until an Mth measurement occasion associated with the second SSB index after the time that is related to reception of the MAC-CE carrying the LTM cell switch command, plus an SSB processing time, where M is an integer having a value greater than or equal to two.

Aspect 13: The method of any of Aspects 1-12, where an interruption time associated with switching from the beam associated with the first SSB index to the TCI state associated with the second SSB index is related to a duration between the first time and the second time.

Aspect 14: The method of Aspect 13, wherein a PDCCH and a PDSCH are not monitored during the interruption time.

Aspect 15: The method of Aspect 13, wherein a PUCCH and a PUSCH are not transmitted during the interruption time.

Aspect 16: The method of any of Aspects 1-15, wherein the TCI state indicated in the LTM cell switch command includes a downlink TCI state and an uplink TCI state, and wherein the second time is a common application time applied to both the downlink TCI state and the uplink TCI state.

Aspect 17: The method of Aspect 16, wherein the common application time is a later of a first application time associated with the downlink TCI state or a second application time associated with the uplink TCI state.

Aspect 18: The method of any of Aspects 1-17, wherein the TCI state indicated in the LTM cell switch command includes a downlink TCI state and an uplink TCI state, and wherein the second time is separately applied to the downlink TCI state and the uplink TCI state.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
receiving a lower-layer triggered mobility (LTM) cell switch command that indicates a transmission configuration indication (TCI) state and a first synchronization signal block (SSB) index, wherein the TCI state indicated in the LTM cell switch command is associated with a second SSB index that differs from the first SSB index;
communicating using a beam associated with the first SSB index until a first time, wherein the first time is related to a random access channel (RACH) procedure triggered by the LTM cell switch command; and
communicating using the TCI state associated with the second SSB index starting at a second time, wherein the second time is related to the first time.

2. The method of claim 1, wherein the first time is related to transmission of a physical random access channel (PRACH) associated with the RACH procedure.

3. The method of claim 1, wherein the first time is related to reception of a physical downlink control channel (PDCCH) scheduling a random access response message associated with the RACH procedure.

4. The method of claim 1, wherein the first time is related to reception of a random access response message associated with the RACH procedure.

5. The method of claim 1, wherein the first time is related to transmission of a physical uplink shared channel (PUSCH) scheduled by a random access response message associated with the RACH procedure.

6. The method of claim 1, wherein the first time is related to successful completion of the RACH procedure.

7. The method of claim 1, wherein the second time corresponds to the first time.

8. The method of claim 1, wherein the second time is at least a minimum time gap after a time that is related to reception of a medium access control (MAC) control element (MAC-CE) activating the TCI state indicated in the LTM cell switch command.

9. The method of claim 8, wherein the minimum time gap is a time until an earliest measurement occasion associated with the second SSB index after the time that is related to reception of the MAC-CE activating the TCI state, plus an SSB processing time.

10. The method of claim 1, wherein the second time is at least a minimum time gap after a time that is related to reception of a medium access control (MAC) control element (MAC-CE) carrying the LTM cell switch command.

11. The method of claim 10, wherein the minimum time gap is a time until an earliest measurement occasion associated with the second SSB index after the time that is related to reception of the MAC-CE carrying the LTM cell switch command, plus an SSB processing time.

12. The method of claim 10, wherein the minimum time gap is a time until an Mth measurement occasion associated with the second SSB index after the time that is related to reception of the MAC-CE carrying the LTM cell switch command, plus an SSB processing time, where M is an integer having a value greater than or equal to two.

13. The method of claim 1, where an interruption time associated with switching from the beam associated with the first SSB index to the TCI state associated with the second SSB index is related to a duration between the first time and the second time.

14. The method of claim 13, wherein a physical downlink control channel (PDCCH) and a physical downlink shared channel (PDSCH) are not monitored during the interruption time.

15. The method of claim 13, wherein a physical uplink control channel (PUCCH) and a physical uplink shared channel (PUSCH) are not transmitted during the interruption time.

16. The method of claim 1, wherein the TCI state indicated in the LTM cell switch command includes a downlink TCI state and an uplink TCI state, and wherein the second time is a common application time applied to both the downlink TCI state and the uplink TCI state.

17. The method of claim 16, wherein the common application time is a later of a first application time associated with the downlink TCI state or a second application time associated with the uplink TCI state.

18. The method of claim 1, wherein the TCI state indicated in the LTM cell switch command includes a downlink TCI state and an uplink TCI state, and wherein the second time is separately applied to the downlink TCI state and the uplink TCI state.

19. A user equipment (UE) for wireless communication, comprising:
one or more memories; and
one or more processors, coupled to the one or more memories, configured to cause the UE to:
receive a lower-layer triggered mobility (LTM) cell switch command that indicates a transmission configuration indication (TCI) state and a first synchronization signal block (SSB) index, wherein the TCI state indicated in the LTM cell switch command is associated with a second SSB index that differs from the first SSB index;
communicate using a beam associated with the first SSB index until a first time, wherein the first time is related to a random access channel (RACH) procedure triggered by the LTM cell switch command; and
communicate using the TCI state associated with the second SSB index starting at a second time, wherein the second time is related to the first time.

20. An apparatus for wireless communication, comprising:
means for receiving a lower-layer triggered mobility (LTM) cell switch command that indicates a transmission configuration indication (TCI) state and a first synchronization signal block (SSB) index, wherein the TCI state indicated in the LTM cell switch command is associated with a second SSB index that differs from the first SSB index;
means for communicating using a beam associated with the first SSB index until a first time, wherein the first time is related to a random access channel (RACH) procedure triggered by the LTM cell switch command; and
means for communicating using the TCI state associated with the second SSB index starting at a second time, wherein the second time is related to the first time.
